(19) United States
(12) Patent Application Publication
(10) Pub. No.: US 2011/0198890 A1
(43) Pub. Date: Aug. 18, 2011

(54) CLOSED-SECTION STRUCTURAL MEMBER FOR A VEHICLE

(75) Inventor: Len V. Peschansky, West Bloomfield, MI (US)

(73) Assignee: GM GLOBAL TECHNOLOGY OPERATIONS, INC., Detroit, MI (US)

(21) Appl. No.: 12/707,152

(22) Filed: Feb. 17, 2010

(51) Int. Cl. B62D 25/20; B23P 23/00

(52) U.S. Cl. 296/205; 29/897.2

(57) ABSTRACT

A member is characterized by an external form, a length, and a boxed cross-section having a substantially uniform shape along the length of the member. The member includes a single joining portion arranged along the length of the member to maintain each of the external form and the boxed cross-section. The member additionally includes two fastening portions, each of the fastening portions arranged proximate to each end of the length, and each fastening portion configured for attachment to one of two substantially parallel rails spaced apart by a distance. The member is configured such that the length is sufficient to span the distance. Additionally, the member is formed out of high-grade steel by a process that enables the use of high-grade steel without employing a re-strike operation to alleviate material spring-back.

### TECHNICAL FIELD

The invention relates to a closed-section structural support member for a vehicle.

### BACKGROUND OF THE INVENTION

Typically, a vehicle includes a structure for enclosing and supporting various vehicle systems, as well as the vehicle passengers. Heavy-duty vehicles, such as pick-up trucks and vans, commonly employ a frame to support a body and a powertrain of the vehicle. On the other hand, light-duty vehicles, such as a majority of passenger cars, often employ a monocoque or unibody construction that eschews a separate body and frame, in favor of a lighter, integrated structure. Additionally, some lighter-duty vehicles employ a combination monocoque structure with a subframe for carrying the vehicle's powertrain. Frequently, additional structural members are used to buttress the vehicle structure, as well as for supporting various chassis and powertrain subsystems.

### SUMMARY OF THE INVENTION

A member is characterized by an external form, a length, and a boxed cross-section having a substantially uniform shape along the length of the member. The member includes a single joining portion arranged along the length of the member to maintain each of the external form and the boxed cross-section. The member additionally includes two fastening portions, each of the fastening portions arranged proximate to each end of the length, and each fastening portion configured for attachment to one of two substantially parallel rails spaced apart by a distance. The member is configured such that the length is sufficient to span the distance. Additionally, the member is formed out of high-grade steel by a process that enables the use of a wide range of material gauges and higher-grade steel without requiring or employing a re-strike operation to alleviate material spring-back.

Roll-forming and a subsequent bending operation may be necessary to achieve the desired external form of the member. The external form of the member may be variable along the length, while the joining portion may be a weld bead. The each fastening portion may include an aperture extending through the cross-section that is configured to accept a device, such as a sleeve and a bolt, for attachment to the rails.

The member may be configured out of high-grade steel as a cross-member to support a transmission assembly in a vehicle. In such a case, the member may further include an aperture arranged between the two fastening portions, wherein the aperture is configured to accept a fastener for attachment to the transmission.

A method of forming a member is also disclosed. The method includes roll-forming a singular, substantially flat piece of high-grade steel to define an external form having a length and a boxed cross-section having a substantially uniform shape along the length of the member. The method additionally includes bending the roll-formed external form in order to generate an appropriate fit and mounting of the member in its end-use environment. The method does not require, and does not include a re-strike operation to alleviate material spring-back. The method additionally includes maintaining the external form and the boxed cross-section by a joining portion.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a vehicle structure including a frame, a powertrain including an engine and a transmission, and a roll-formed cross-member attached to the frame and supporting the transmission;

FIG. 2 is a schematic perspective view of the cross-member shown in FIG. 1; and

FIG. 3 is an illustration of a cross-section of the cross-member shown in FIGS. 1 and 2.

### DESCRIPTION OF THE PREFERRED EMBODIMENTS

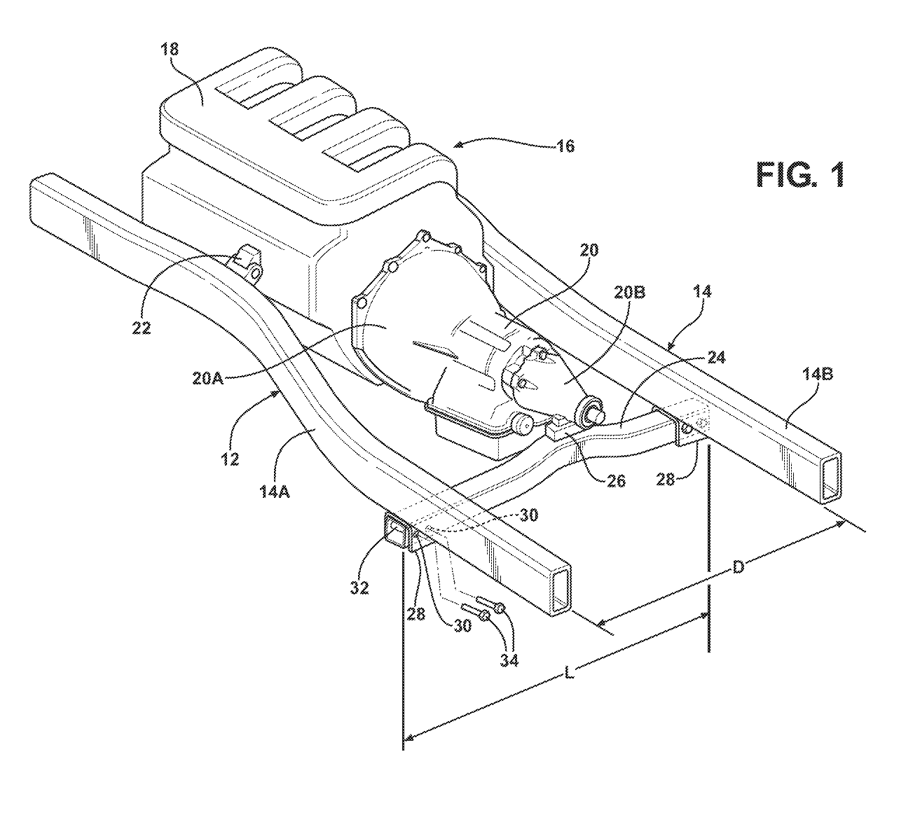

Referring to the drawings, wherein like reference numbers refer to like components, FIG. 1 shows a perspective schematic view of a vehicle structure 12. Vehicle structure 12 is made up of a vehicle body (not shown) constructed from a number of components and sub-structures, as understood by those skilled in the art, and a frame 14. As shown, vehicle structure 12 is adapted for use in a rear-wheel drive configuration, but a four-wheel drive configuration is also possible, as will be appreciated by those skilled in the art.

Frame 14 includes two substantially parallel frame rails, 14A and 14B, separated in vehicle structure 12 by a distance D. Frame rails 14A and 14B are typically made from steel, and are formed by any appropriate method, such as hydro-forming, roll-forming, stamping, and welding. Frame 14, as opposed to a unibody structure, is typically employed in heavier-duty work vehicles, such as pick-up trucks and vans, commonly used for carrying loads. Frame 14 enables a work vehicle to handle considerable stress while supporting the body, vehicle powertrain 16, and vehicle passengers, while carrying various additional loads without experiencing structural damage.

Powertrain 16 includes an engine 18 and a transmission assembly 20 coupled to the engine, and configured to transmit engine torque to the driven wheels via a driveshaft (not shown). In addition to engine 18 and transmission assembly 20, powertrain 16 may also include an electric motor/generator (not shown) for hybrid propulsion of the subject vehicle, as understood by those skilled in the art. Transmission assembly 20 includes an input member (not shown) connected to engine 18, and an output member (not shown) connected to the driven wheels, as understood by those skilled in the art. Transmission assembly 20 also includes a gear train (not shown) and torque transmitting members (not shown) operatively connecting the input and the output members, and arranged to enable selection of appropriate gear ratios for most effective propulsion of the subject vehicle.

Engine 18 is mounted on frame 14 via a pair of engine mounts 22, with one mount positioned on either side of the engine (due to the perspective view shown in FIG. 1, only a single mount is shown). Mounts 22 are specially designed to support the mass of engine 18, as well as to absorb vibration of a running engine, and withstand the torque couple that is generated by the engine during propulsion of the subject vehicle. Transmission assembly 20 is coupled to engine 18 at transmission bell housing 20A via appropriate fasteners (not shown), and is supported at transmission tail end 20B by a structural cross-member 24. A transmission mount 26 is positioned between cross-member 24 and tail end 20B in order to support the mass of transmission assembly 20, as well as to absorb vibration transmitted from the running engine and the driveshaft, and withstand the torque couple generated by engine 18 during propulsion.

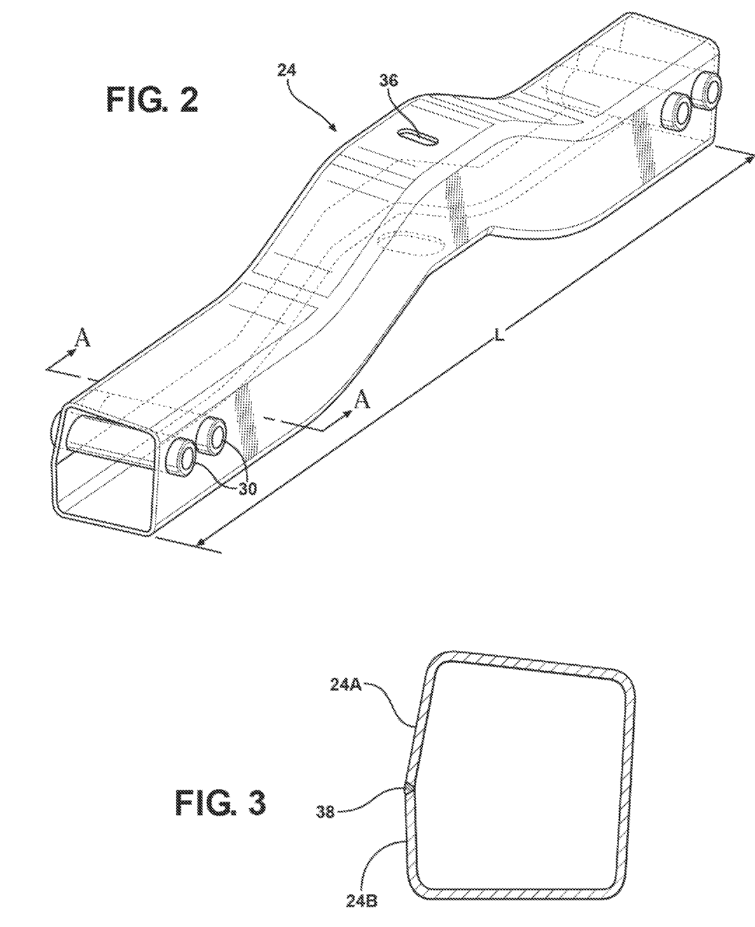

Cross-member 24 may be roll-formed and subsequently bent from steels ranging from typical low-grade carbon steel to high-grade type, for example GMW3032M-ST-S hot-rolled HR550 or cold-rolled CR560, while using a wide range of material gauges, as understood by those skilled in the art. The subsequent bending operation may need to be employed to generate an appropriate fit and mounting of the transmission assembly 20 in the vehicle structure 12. Cross-member 24 is characterized by a length L which is sufficient to span distance D between the rails 14A and 14B. Member 24 has a form that is variable along length L (shown as an inverted sea-gull shape in FIGS. 1 and 2), that is typically achieved by a bending operation. Cross-member 24 is attached to frame 14 by a pair of brackets 28, with one bracket positioned on either frame rail 14A or 14B (due to the perspective view shown in FIG. 1, only a single bracket is shown). Each bracket 28 includes a pair of apertures 30. Cross-member 24 has a pair of fastening portions, shown as including a pair of rigid sleeves 32 arranged proximate to each end of length L. Each pair of sleeves 32 is configured for attachment to one of the rails 14A and 14B.

When cross-member 24 is positioned for connection to frame rails 14A and 14B, openings of the rigid sleeves 32 match up with apertures 30. A pair of appropriate fasteners 34 is inserted through both, apertures 30 and sleeves 32. Subsequently, fasteners 34 are tightened to assure reliable attachment of the cross-member to frame 14. Accordingly, powertrain 16 is supported by frame 14, such that the combined mass of engine 18 and transmission assembly 20 is distributed among four locations on frame 14—the pair of engine mounts 22, and the pair of brackets 28. Furthermore, the vibration of powertrain 16 is absorbed at three locations—the pair of engine mounts 22 and the transmission mount 26.

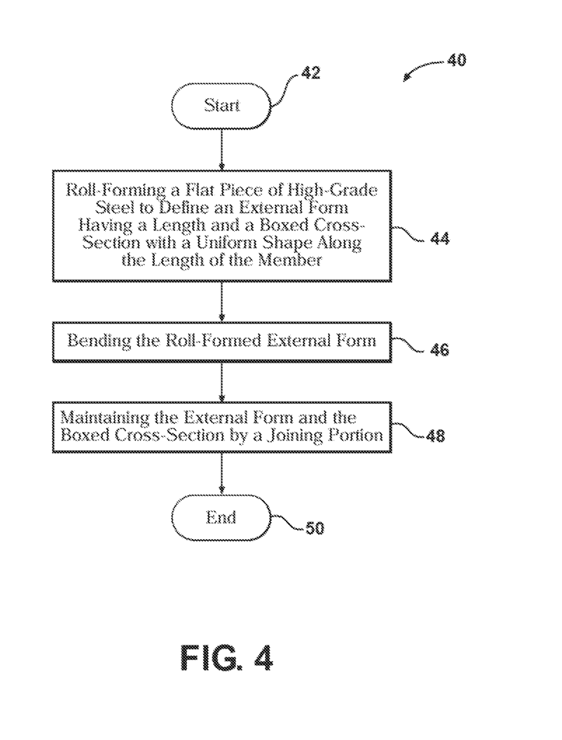

In FIG. 2, cross-member 24 is shown separately from vehicle structure 12. Cross-member 24 includes an aperture 36 for accepting a fastener (not shown) employed to attach transmission mount 26 to the cross-member. Cross-member 24 has a boxed or polygon cross-section A-A that is as identified in FIG. 2 and shown in true view in FIG. 3. Cross-section A-A is boxed, i.e., has a fully-enclosed shape to transfer loads throughout its perimeter wall, for effective load bearing and stiffness. Boxed cross-section A-A may have a largely quadrilateral, and even a substantially square shape. Although the external shape or form of cross-member 24 is variable along length L of the cross-member, the boxed cross-section A-A has a substantially uniform shape along the entire length L. Such uniform shape is crucial for enabling the manufacture of cross-member 24 by the process of roll-forming. Other section parameters, such as width, height, angles and radii of the cross-member 24 are not limited, as long as they are constant along length L, and follow common practices of the roll-forming process, as understood by those skilled in the art. The above mentioned material grade selection and the external form of the member 24 are typically a function of expected vehicle loads, durability, and packaging requirements.

In general, roll-formed components have an advantage over extrusions and/or stampings of similar shapes, in that a roll-formed part is generally significantly lighter and stronger, having been work-hardened in a cold state. Additionally, roll-forming dispenses with a costly re-striking operation that is frequently needed to alleviate spring-back inherent to components formed from high-grade steel by other methods, such as stamping. As a result, the use of high-grade steel for cross-member 24 permits selection of smaller gage material, thus additionally reducing weight of vehicle structure 12 without sacrificing vehicle performance and durability. After cross-member 24 is roll-formed and the boxed cross-section A-A is created with unconnected lateral edges, a joining portion, shown as a weld bead 38, is generated along the lateral edges 24A and 24B to permanently close and maintain the boxed cross-section (shown in FIG. 3). The result is a relatively light, strong, and cost-effective cross-member 24 that is capable of withstanding high levels of stress during operation of the subject vehicle.

A method 40 of forming cross-member 24 is shown in FIG. 4, and described below with respect to FIGS. 1-3. The method commences in frame 42, and proceeds to frame 44. In frame 44, a singular, substantially flat piece of high-grade steel is roll-formed to define an external form having length L, cross-section A-A, and a substantially uniform shape along the length L. Following frame 44, the method continues to frame 46, where the roll-formed external form is bent into the shape of the cross-member 24. After frame 46, the bent external form and boxed cross-section A-A are maintained by the joining portion, weld bead 38, in frame 48. The weld bead 38 is generated along the lateral edges 24A and 24B that have been formed to meet at the joining portion in order to permanently close and maintain the boxed cross-section. Method 40 concludes in frame 50, with the fully formed cross-member 24 having been completed. Additional features may be added in-process or subsequent to frame 48, such as configuring fastening portions with apertures 30 for accepting sleeves 32, and forming aperture 36. As such, method 40 is employed to form cross-member 24 out of high-grade steel without employing a re-strike operation to alleviate material spring-back.

While the best modes for carrying out the invention have been described in detail, those familiar with the art to which this invention relates will recognize various alternative designs and embodiments for practicing the invention within the scope of the appended claims.

1. A member comprising:
an external form;
a length;
a boxed cross-section having a substantially uniform shape along the length of the member;
a single joining portion arranged along the length of the member to maintain each of the external form and the shape of the boxed cross-section; and
two fastening portions, each of the fastening portions arranged proximate to each end of the length, and each fastening portion configured for attachment to one of two substantially parallel rails spaced apart by a distance;
wherein:
the length is sufficient to span the distance; and
the member is formed by a process that enables the use of the high-grade steel without employing a re-strike operation to alleviate material spring-back.

2. The member of claim 1, wherein the process is that of roll-forming and bending.

3. The member of claim 1, wherein the external form of the member is variable along the length.

4. The member of claim 1, wherein the joining portion is a weld bead.

5. The member of claim 1, wherein each of the two fastening portions includes an aperture extending through the cross-section, and is configured to accept a fastener for attachment to the rails.

6. The member of claim 1, wherein the member is configured out of high-grade steel as a cross-member to support a transmission assembly in a vehicle.

7. The member of claim 6, further including an aperture arranged between the two fastening portions, configured to accept a fastener for attachment to the transmission assembly.

8. A vehicle structure comprising:
a frame having two substantially parallel rails spaced apart by a distance;
a member having:
an external form;
a length sufficient to span the distance;
a boxed cross-section having a substantially uniform shape along the length of the member;
a single joining portion arranged along the length of the member to maintain each of the external form and the boxed cross-section; and
two fastening portions, each of the fastening portions arranged proximate to each end of the length, and each fastening portion attached to one of the two rails;
wherein the member is formed by roll-forming and bending which enables the use of high-grade steel without requiring a re-strike operation to alleviate material spring-back.

9. The vehicle structure of claim 8, wherein the member is formed from high-grade steel.

10. The vehicle structure of claim 8, wherein the external form of the member is variable along the length.

11. The vehicle structure of claim 8, wherein the joining portion is a weld bead.

12. The vehicle structure of claim 8, wherein each fastening portion includes an aperture extending through the cross-section, and is configured to accept a fastener for attachment to the rails.

13. The vehicle structure of claim 8, wherein the member is cross-member configured to support a transmission assembly.

14. The vehicle structure of claim 13, wherein the member includes an aperture arranged between the two fastening portions, configured to accept a fastener for attachment to the transmission assembly.

15. A method of forming a member comprising:
roll-forming a singular, substantially flat piece of high-grade steel to define an external form having a length and a boxed cross-section having a substantially uniform shape along the length of the member, without employing a re-strike operation to alleviate material spring-back;
bending the roll-formed external form; and
maintaining the external form and the boxed cross-section by a joining portion.

16. The method according to claim 15, wherein the joining portion is a weld bead.

17. The method according to claim 15, wherein the flat piece of material has edges that meet at the joining portion when the piece is roll-formed.

18. The method according to claim 15, further comprising configuring two fastening portions, such that each fastening portion is proximate to each end of the length.

19. The method according to claim 18, further comprising generating an aperture extending through the cross-section at each fastening portion, such that each fastening portion is configured to accept a device for attachment to a rail of a vehicle frame.

20. The method according to claim 19, wherein the member is configured as a cross-member for supporting a transmission assembly in a vehicle.
